(19) United States
(12) Patent Application Publication
(10) Pub. No.: US 2003/0230894 A1
(43) Pub. Date: Dec. 18, 2003

(54) Brazeless connector for fluid transfer assemblies

(76) Inventors: Rafael L. Cleveland, Summerfield, FL (US); Terence E. Skiba, Ocala, FL (US); Herbert R. Lemaster, Ocala, FL (US)

Correspondence Address: DAYCO PRODUCTS, LLC, 1 PRESTIGE PLACE, MIAMISBURG, OH, 45342, US

(21) Appl. No.: 10/170,749

(22) Filed: Jun. 13, 2002

(51) Int. Cl. F16L 33/00

(52) U.S. Cl. 285/239

(57) ABSTRACT

An end fitting connector having an axial bore through which a fluid is conveyed; comprises: a stem portion which includes a first tubular body having a first annular rim disposed at a distal end of the first tubular body, wherein the distal end is adapted to be inserted into an inner channel of a fluid transport tube. The stem portion includes at least one annular sealing member extending circumferentially outward from an outer surface of the first metal tubular body; and a connector portion opposite the distal end of the first tubular body. The connector portion includes a second tubular body having a second annular rim disposed at a distal end of the second tubular body, wherein the distal end of the second tubular body is adapted to be coupled with another fluid conveying structure.

### BACKGROUND OF THE INVENTION

The present invention relates to a coupling device for tubing connections and method for connecting tubes using such coupling devices. More specifically, the present invention relates to the connection of a metal fluid transfer tubing to other metallic connections without having to braze or weld the two pieces together.

Hose coupling devices are known. For example, U.S. Pat. No. 3,653,692 to Henson describes an elastomeric hose connected to a nipple having a circumferential barb. The hose is stretched allowing a ring member to slide down the hose and over the barbed nipple where it creates a compression of the hose when the hose is no longer stretched. U.S. Pat. No. 3,477,750 to Powell discloses a pipe section joined by a sleeve which includes annular teeth. The pipe is made of iron and the sleeve is preferably made of the same material. The design requires an additional sealing means in the form of a thin elastomeric membrane and further requires that the teeth be formed onto the pipe one at a time. U.S. Pat. No. 3,689,111 to Osmun; U.S. Pat. No. 5,707,087 to Ridenour et al.; U.S. Pat. No. 4,114,930 to Perkins et al.; and U.S. Pat. No. 5,423,581 to Salyers all teach coupling devices for connecting tubing to a fitting assembly to prevent leaks.

Current practice in the tube connector art requires that a heavy clamping or crimping force be applied about a collar around the tube and the fitting to provide a fluid-tight seal and to provide pull-off resistance to the assembly. In such cases, the tube is compressed radially inward to make a seal. However, it is difficult to make a permanent leak-tight seal, because the tube, even though malleable, tends to have sufficient elasticity to relax somewhat and deform, upon release of the clamping or crimping pressure just enough to compromise the fluid-tight seal, particularly, when the fluid is under high pressure for an extended period of time.

End connections on fluid transfer assemblies such as on power steering pressure and return lines require tight tolerances and high strength to prevent the fluid from leaking from the assembly. Conventional connectors are not able to achieve the required tolerances or the strength required to prevent such leaks. Typically, these connectors are brazed or welded to the fluid transfer tubing. When an assembly is brazed, it undergoes high temperatures which are generally detrimental to any coating or plating on the assembly or on the tubing. When steel or other low corrosion tolerance material is used as the assembly material, the assembly must be treated in order to protect it from the environment. Typical methods of protecting the assembly include pre-treatment of the assembly using electroplating and painting techniques. However, the high temperatures associated with conventional brazing or welding commonly causes the electroplating or painting to burn off during processing.

Therefore, it would be advantageous to have a connector for fluid transfer assemblies which eliminate the drawbacks of previously known connector assemblies.

### SUMMARY OF THE INVENTION

It is an object of the present invention to provide a tube, preferably a metal tube and a connector assembly, preferably a metal connector assembly, and method for providing such assembly which is leak-free at high pressure for extended periods of time, whereby the need for welding or brazing a metal fluids transfer tubing to other metallic connections is eliminated.

In accordance with the present invention, a tube connector is used to connect a fluid transfer tubing to other metallic connections in a manner to provide a leak-free fluid transfer assembly. The tube connector comprising a rigid tubular member having an annular channel exhibiting an inner diameter extending along its longitudinal axis for transporting a fluid therethrough. The rigid tubular member comprises a first end portion, a second end portion and a tubular body portion. The tube connector further includes an axial bore which is adapted to convey a fluid therethrough. The first end portion includes a stem portion having a uniform outer surface diameter adapted to be inserted into an inner channel of a metal tubular structure, the stem portion having at least one sealing means extending uniformly outward from the outer surface diameter of the stem portion.

The second end portion includes a forward tubular structure which may or may not have a uniform outer diameter. The tubular body portion intermediate the first and second ends has an outer diameter larger than the second end. Typically, the rearward end of the tubular body portion has a surface perpendicular to the tubular portion of the second end forming a perpendicular shoulder against which the end of the metal tubular structure abuts upon insertion of the tube connector into the channel of the metal tubular structure, wherein the second end of the rigid tubular member is sealably secured to the metal connector by permanently and uniformly deforming the metal tubular structure under high pressure onto the sealing members.

In accordance with the present invention, a metal fitting pre-coated with a thin metallic coating such as zinc-nickel or zinc-cobalt is provided with one or more concentric annular metal barbs on the outer diameter of the metal fitting. The metal fitting is then loosely inserted into the end of the metal tube where the fitting is joined to the tube in a fluid-tight seal created by crimping, swaging, rolling or other means of permanently deforming the metal tube uniformly around the metal barbed fitting. The fluid-tight seal is created by the high pressure of the metal annular barbs pressed against the inner diameter of the metal tube, wherein the inner surface of the pre-coated metallic tube is permanently deformed corresponding to the configuration of the metal annular barbs on the metallic filling. The sealing is further enhanced by the permanent deformation of the inner diameter of the metal tube as it molds itself around the metal barbs, providing an intimate surface-to-surface relationship created between the two surfaces. In this respect, it is important that both the metal tube and the metal barbs on the fitting exhibit similar hardness and thermal expansion rate characteristics in order to create a leak free seal. Similar characteristics allow for the materials to flow and fill any voids or leak paths which may tend to form. The similar metallic materials also provide good leak resistance with respect to temperature and pressure variations.

### BRIEF DESCRIPTION OF THE DRAWING

FIG. 1 is a longitudinal view, in cross section of a tube connector of the present invention ready for assembly with a metal fluid transfer tube;

FIG. 2 is a longitudinal view, in cross section of a tube of the present invention assembled with a metal fluid transfer tube;

FIG. 3 is a longitudinal view, in a cross section of the tube of FIG. 2 wherein the tubular structure is compressed by a compressor means; and

FIG. 4 is a longitudinal view, in cross section of another embodiment of the present invention.

### DETAILED DESCRIPTION OF THE INVENTION

In accordance with the present invention, a metal tube connector is permanently coupled to a metal fluid transfer tube to provide a leak-free metal tube assembly, such as those used in automotive power steering assemblies, air conditioning assemblies, etc., without having to weld or braze the two pieces together. Since the present invention does not require the high temperatures associated with prior methods of coupling a metal connector to a metal tubing, the metal tubing may be pre-coated prior to making the assembly.

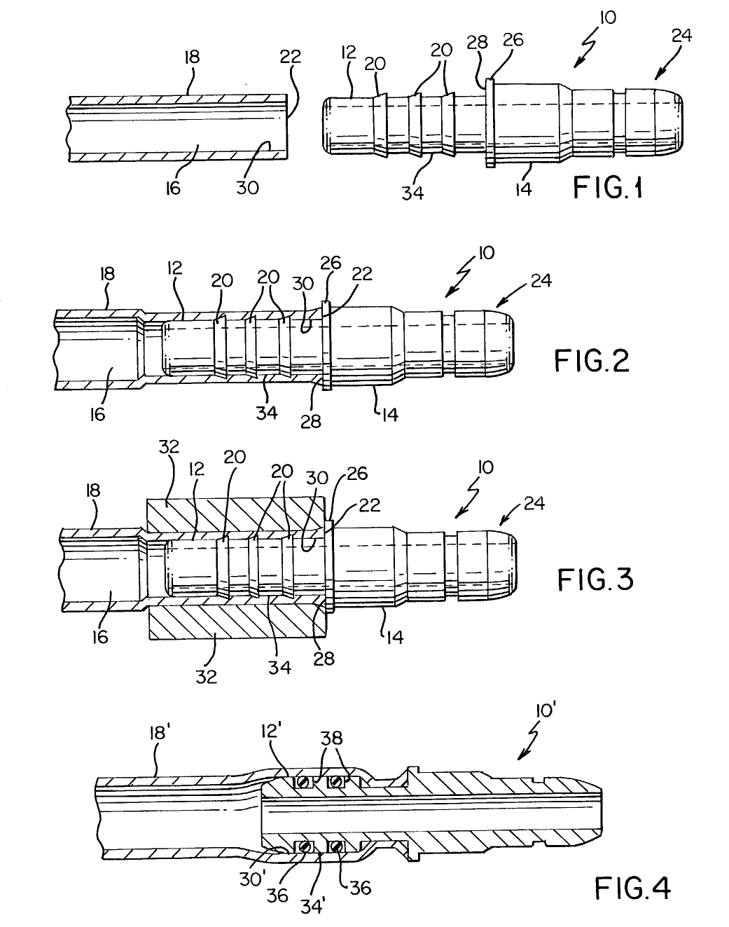

As illustrated in FIGS. 1-3, the metal end fitting 10 of the first embodiment of the present invention includes a stem portion 12 defining one end of the end fitting 10 and a coupling portion 14 defining another end of the end fitting 10. The stem portion 12 is adapted to be inserted into an end 22 of an inner channel 16 of a metal tubular structure 18 and secured thereto to provide a leak-free fitting.

The stem portion 12 includes one or more annular serrations or barbs 20 circumferentially disposed around the outer circumference of the stem portion 12. The stem portion 12 containing the serrations or barbs 20 is loosely inserted into the end 22 of the metal tubular structure 18 and subjected to crimping, swaging, rolling or other method of permanently deforming the metal tubing 18 uniformly onto the stem portion 12. The leak-free seal is created by the high pressure exerted upon the metal tubular structure 18 wherein the annular serrations or barbs 20 are pressed against and into the inner surface 30 of the metal tubular structure 18. The sealing is further enhanced by the permanent deformation of the inner diameter of the metal tubing 18 as it molds around the annular serrations or barbs 20, creating an intimate mating of both surfaces. It is essential that the metal tubular structure 18 and the serrations or barbs 20 have the same or similar characteristics such as hardness and thermal expansion rates in order for the seal to be leak-free. Similar hardness of the metal materials used in the metal tubular structure 18 and in the serrations or barbs 20 allow both metal materials to exhibit similar flow characteristics and, therefore, fill any potential voids or leak paths. Furthermore, both materials should have similar thermal expansion rates, otherwise, they may be prone to leaks upon being exposed to temperature variations. Typically, the metal tubular structure 18 is constructed of a low corrosion tolerance material, such as steel or the like which is pre-coated to prevent corrosion. Other materials having properties similar to the material used in forming the barbs may be employed to form the tubular structure.

The material used in manufacturing the tubular structure 18, the stem portion 12 and the serrations or barbs 20 of the present invention should be high quality and free of voids, pits, laps, cracks, folds, seams, slivers and other defects. When using these materials in the assemblies, they should be treated to protect the metal from the environment. Since connections made in accordance with the present invention do not require high temperatures, pre-treated metal tubes such as nylon-coated metal tubes, or metal tubes which have been electroplated, painted or similarly treated, can be connected to an end fitting without the disadvantages associated with the prior art.

The serrations or barbs 20 on the stem portion 12 should be as sharp as the machining operation can make them to provide an adequate seal. It is also important that the serrations or barbs 20 be concentric to insure an even and constant penetration of the serrations or barbs 20 into the metal tubular structure 18 upon being crimped, swaged, rolled, etc. under high pressure. The pressure needed to deform the tubular structure may be applied by suitable compression means 32 such as hydraulics, air-over-hydraulics, pneumatic or any other suitable method (see FIG. 3).

The shape of the serrations or barbs 20 is also important in providing the leak-free seal. The serrations or barbs 20 are tapered to extend outwardly from the outer surface 34 of stem portion 12, providing a forward rim defining a circumferential apex of an annular shoulder surface of the rim to provide a leak-free seal.

The number of serrations or barbs 20 present on the stem portion 12 is not critical. One serration or barb is sufficient in most applications; however, one may want to employ a plurality of serrations or barbs to provide backup seals in the assembly. Typically, two or three serrations or barbs are preferred.

The metal coupling portion 14 of the metal end fitting 10 includes a connecting portion 24 extending longitudinally outward from the stem portion 12. The connecting portion 24 connects the coupling portion 14 to a mated fitting (not shown). Typically, the connecting portion 14 includes flanged portion 26 adapted to receive a tool, such as a wrench, to hold the coupling portion 14 as the end fitting 10 is being connected to the mated fitting. The flanged portion 26 defines a rear shoulder surface 28. The connection portion 24 can further include a threaded portion (not shown) extending longitudinally outward from the flanged portion 24. The threaded portion can comprise a male threaded portion or a female threaded portion. Additionally, the metal coupling portion 14 can include any suitable coupling mechanism, such as quick disconnect and quick connect type fittings, or other types of conventional coupling mechanisms known in the art.

When the metal end fitting 10 is inserted into the metal tubular structure 18, the metal tubular structure 18 is compressed radially inward around the stem portion 12 of the end fitting 10 such that the inner channel 16 of the tubular structure 18 engages the serrations or barbs 20 providing a leak-free seal at each of the serrations or barbs 20. The serrations or barbs 20 not only provide leak-free seals but they also increase the pull-off resistance of the end fitting assembly 10.

Another embodiment of the invention is shown in FIG. 4, where the stem portion 12′ of end fitting 10′ includes one or more annular troughs 38 around the outer surface 34′ of the stem portion 12′ to provide a leak-free environment in an assembly. Each of the annular troughs 38 is adapted to contain an O-ring member 36, the outer diameter of which is slightly greater than the outer diameter of the stem portion 12′. The O-ring member 36 is made of a resilient material such as butyl rubber, nitrile-butadiene rubber, hydrogenated nitrile-butadiene rubber, silicone rubber, chlorosulfonated polyethylene (CSM), ethylene-propylene-diene rubber (EPDM) or other appropriate material for the fluid being retained.

When the stem portion 12′ is inserted into an open end of a metal tubular structure 18′ and then subjected to high pressure means, similar to that described above and shown in FIG. 3, to clamp the metal tubular structure 18′ around the stem 12′, the resilient O-rings 36 are compressed to form an intimate contact with the inner surface 30′ of the tubular structure 18′ as well as the annular trough 38 to provide a leak-free seal therein. This second embodiment of the invention allows one to use materials for the connector and the metal tubular structure which are not necessarily similar in hardness or have a thermal expansion rate. For example, in this embodiment the metal connector may be made of steel and the metal tubular structure may be aluminum or vice versa.

Although the present invention has been fully described in connection with a preferred embodiment thereof and with reference to the accompanying drawing, various changes and modifications will occur to those skilled in the art. Accordingly, such changes and modifications are to be understood as being within the scope of the present invention as defined by the appended claims.

What is claimed is:

1. An end fitting connector having an axial bore through which a fluid is conveyed; said end fitting connector comprising:
a stem portion which includes a first metal tubular body having a first annular rim disposed at a distal end of said first tubular body, wherein said distal end is adapted to be inserted into an inner channel of a fluid transport tube, wherein said end fitting is permanently sealed to said fluid transport tube, said stem portion including at least one annular metal sealing member extending circumferentially outward from an outer surface of said first tubular body; and
a connector portion opposite the distal end of said first tubular body, said connector portion including a second tubular body having a second annular rim disposed at a distal end of said second metal tubular body, wherein said distal end of said second tubular body is adapted to be coupled with another fluid conveying structure.

2. The end fitting of claim 1, wherein said annular sealing member comprises at least one metal barb.

3. The end fitting of claim 2, wherein said sealing member comprises two or three metal barbs.

4. The end fitting of claim 2, wherein said at least one metal barb has a forward rim, said forward rim defining a circumferential apex of an annular shoulder surface of said barb.

5. The end fitting of claim 4, wherein said annular shoulder surface is perpendicular to said first tubular body.

6. The end fitting of claim 2, wherein said at least one metal barb has a tapered rearward surface extending from said apex toward said first tubular body.

7. The end fitting of claim 4, wherein said circumferential rim exhibits a sharp edge.

8. The end fitting of claim 1, wherein said connector portion is adapted to engage a fluid transport member, said fluid transport member having an axial bore through which a fluid is conveyed.

9. The fitting of claim 2, wherein said fluid transport tube is capable of being uniformly deformed onto and around said at least one metal barb upon being subjected to high concentric pressure thereat to create a leak-free seal therebetween.

10. The end fitting of claim 9 wherein said at least one metal barb and said fluid transport tube are made from metals having a similar hardness.

11. The end fitting of claim 10, wherein said metal is steel.

12. The end fitting of claim 9, wherein said fluid transport tube is capable of remaining uniformly deformed onto and around said at least one metal barb upon being subjected to variations in temperature.

13. The end fitting of claim 12, wherein said transport tube and said at least one metal barb are made from metals having similar thermal expansion rates.

14. The end fitting of claim 13, wherein said metal is steel.

15. The end fitting of claim 1, wherein said at least one annular sealing member comprises at least one annular collar disposed circumferentially along said outer surface of said first tubular body.

16. The end fitting of claim 15, wherein said annular sealing member is an O-ring made from a resilient material selected from the group consisting of: butyl rubber, nitrile-butadiene rubber, hydrogenated nitrile-butadiene rubber, silicone rubber, chlorosulfonated polyethylene (CSM), and ethylene-propylene-diene rubber (EPDM).

17. The end fitting of claim 15, wherein said at least one annular sealing member is seated in corresponding depressions disposed along said outer surface of said first tubular body.

18. The end fitting of claim 15, wherein said metal transport tube is made of steel.

19. The end fitting of claim 15, wherein said metal fluid transport tube is aluminum.

20. The end fitting of claim 1, wherein said end fitting and/or said fluid transport tube is pre-coated or plated with a protecting material to protect said end fitting and/or said fluid transport tube from environmental conditions.

21. The end fitting of claim 20, wherein said protective material is nylon.

22. A metal end fitting connector having an axial bore through which a fluid is conveyed, said metal end fitting connector comprising:
a metal stem portion pre-coated with a protective material, said pre-coated stem portion including a first metal tubular body having a first annular rim disposed at a distal end of said first metal tubular body, wherein said distal end is adapted to be inserted in metal to an inner channel of a metal fluid transport tube, wherein said end fitting is permanently sealed to said fluid transport tube, said metal stem portion including at least one annular barb extending circumferentially outward from an outer surface of said first metal tubular body, wherein said annular metal barb has a forward rim defining a sharp edged circumferential apex of an annular shoulder surface of said metal barb, wherein said annular shoulder surface is perpendicular to said first metal tubular body, and a tapered rearward surface extending from said apex toward said first metal tubular body; and
a metal connector portion opposite the distal end of said first metal tubular body, said metal connector portion including a second metal tubular body having a second annular rim disposed at a distal end of said second metal tubular body, wherein said distal end of said second metal tubular body is adapted to be coupled with another fluid conveying structure.

23. The metal end fitting of claim 22, wherein said first tubular portion is a steel tubular body.

24. The metal end fitting of claim 22, wherein said metal fluid transport tube is a steel fluid transport tube.

25. The metal end fitting of claim 22, wherein said at least one annular metal barb is at least one annular steel barb.

26. The metal end fitting of claim 22, wherein said second metal tubular portion is a steel tubular portion.

27. The metal end fitting of claim 22, wherein said coupling means is an externally threaded coupler capable of engaging an internally threaded coupler.

28. The metal end fitting of claim 22, wherein said coupling means is an internally threaded coupler capable of engaging an externally threaded coupler.

29. The metal end fitting of claim 22, wherein said coupling means is a quick connect/quick disconnect coupling.

30. The metal end fitting of claim 22, wherein said protective material is nylon.

31. A method of providing a leak-free seal between an end fitting and a fluid transport tube, said method comprising:
providing an end fitting pre-coated with a protective material, said pre-coated end fitting having a stem portion which includes a first tubular body having a first annular rim disposed at a distal end of said first tubular body, wherein said distal end is adapted to be inserted into an inner channel of a fluid transport tube, wherein said end fitting is permanently sealed to said fluid transport tube, said stem portion including at least one annular sealing member extending circumferentially outward from an outer surface of said first tubular body; and
subjecting said fluid transport tube to a pressure sufficient to cause said fluid transport tube to permanently deform onto and around said annular sealing member.

32. The method of claim 31, wherein said annular sealing member comprises at least one metal barb.

33. The method of claim 32, wherein said at least one metal barb and said metal fluid transport tube are made from metals having a similar hardness and a similar thermal expansion rate.

34. The method of claim 33, wherein said metal barb and said metal fluid transport tube are steel.

35. The method of claim 34, wherein said steel barb has a forward rim defining a sharp edged circumferential apex of an annular shoulder surface of said steel barb, said annular shoulder surface being perpendicular to said first steel tubular body, and a tapered rearward surface extending from said apex toward said first steel tubular body.

36. The method of claim 31 wherein said protective material is nylon.
